(19) United States
(12) Patent Application Publication
(10) Pub. No.: US 2003/0016911 A1
(43) Pub. Date: Jan. 23, 2003

(54) Random access optical add/drop switch

(76) Inventors: Samad Talebpour, Richmond Hill (CA); Tino Alavie, Thornhill (CA); Ming Gang Xu, Toronto (CA)

Correspondence Address: Ralph A. Dowell, Dowell & Dowell, P.C., Suite 309, 1215 Jefferson Davis Hwy., Arlington, VA, 22202, US

(21) Appl. No.: 10/193,686

(22) Filed: Jul. 12, 2002

Related U.S. Application Data
(60) Provisional application No. 60/306,158, filed on Jul. 19, 2001.

(51) Int. Cl. G02B 6/34; G02B 6/26

(52) U.S. Cl. 385/37; 385/10; 385/27

(57) ABSTRACT

The present invention relates to a method and devices for multiplexing and demultiplexing optical signals. The present invention relates to a method and devices for integrating the multiplexer and demultiplexer functionality with the switch array. The wavelength switchable optical filter comprises an optical waveguide having a grating along a section thereof, the grating comprising a pre-selected number of spaced sub-gratings with each sub-grating having a sub-grating period, the grating has a spectral response characterized by a pre-selected number of spaced band-pass windows spanning a pre-selected wavelength range. The optical filter includes modifying means connected to the optical waveguide for modifying the sub-grating period, refractive index or a combination thereof for selectively opening or closing each of said band pass windows independently of all the other band pass windows.

### CROSS REFERENCE TO RELATED U.S. PATENT APPLICATIONS

This patent application relates to U.S. provisional patent application Serial No. 60/306,158 filed on Jul. 19, 2001 entitled Random Access Optical Add/Drop Multiplexer.

### FIELD OF THE INVENTION

The present invention relates to a method and devices for switching and routing multiplexed optical signals. The present invention relates to a method and devices for integrating the multiplexer and demultiplexer functionality with the switch for switching and routing light signals.

### BACKGROUND OF THE INVENTION

In wavelength division multiplexed (WDM) fiber optic systems, optical signal with individual wavelengths are combined and subsequently launched into a common fiber through an optical multiplexer. Multiplexing of different wavelengths into a common fiber increases the carrying capacity, or bandwidth, of that fiber thereby eliminating the need to lay down more fibers. After the information-carrying light traverses the fiber a predetermined distance, it passes through an optical demultiplexer where individual wavelengths are separated. These individual wavelengths are subsequently undergone optical-to-electrical conversion and then disaggregated to slower speed signals. Finally they are processed and switched prior to being redirected towards their final destination. As it turns out, the bulk of the traffic coming into such a processing center, called a node, is expressed through and only a small portion is dropped locally. Therefore, the process of multiplexing and demultiplexing all the channels so that only a small portion can be accessed through any one node is highly inefficient in that it uses unnecessary optical and electrical components and adds to the complexity and hence cost of such systems and networks.

Fixed and tunable optical add/drop multiplexers have been the topic of recent publications [Al-Salameh et. al, U.S. Pat. No. 6,208,442] in that they allow network flexibility and provide a means for provisioning bandwidth quickly and more cost efficiently. These approaches, however, use a means for de-multiplexing the input wavelengths and then using some form of switching fabric to operate on individual wavelengths. By contrast, tunable fiber Bragg grating based add/drop multiplexers [Liaw et. al, U.S. Pat. No. 6,201,909, U.S. Pat. No. 5,982,518, U.S. Pat. No. 6,226,428] use the grating for both de-multiplexing and selecting the wavelength. In applications where multiple wavelengths are to be selected, there are as many gratings as the number of wavelengths to be addressed.

Using an all-optical approach for selectively and dynamically inserting and extracting wavelengths or channels within a WDM signal stream would significantly reduce the overhead on such systems. This can be directly measured by a dramatic reduction in the number of optical to electrical back to optical (O-E-O) regenerators and the associated electronics. A re-configurable optical add/drop multiplexer would provide the flexibility necessary to drop and add an arbitrary set of wavelengths from an input set while leaving the remaining portion of the wavelength virtually untouched. One of the common approaches for building a re-configurable add/drop multiplexer is to use a set of matching multiplexers and demultiplexers and sandwiching a series of 2×2 optical switches between them. In this way, each wavelength is divided into a separate fiber, which is then expressed through or dropped using the optical switch. This approach, however, is not preferred since it will require multiplexers, demultiplexers and many optical switches, not to mention the fact that it will be lossy, bulky and expensive, as it will require a large number of components.

It would be very advantageous to provide a method and devices for multiplexing and demultiplexing optical signals, which can avoid the above-noted drawbacks.

### SUMMARY OF THE INVENTION

The present invention relates to a method and devices for integrating the multiplexer/demultiplexer functionality with the switch array. This then alleviates the need for having separate components and alignments thereof. Furthermore, the integrated design provides for superior optical characteristics, can be produced at a fraction of the cost and is generally more compact.

In one aspect the present invention provides a wavelength switchable optical filter, comprising:

a) an optical waveguide having a grating along a section thereof, said grating comprising a pre-selected number of spaced sub-gratings with each sub-grating having a sub-grating period, said grating having a spectral response characterized by a pre-selected number of spaced band-pass windows spanning a pre-selected wavelength range; and

b) modifying means connected to said optical waveguide for modifying at least one of said sub-grating period, refractive index and a combination of sub-grating period and refractive index of each individual sub-grating for selectively opening or closing each of said band pass windows independently of all the other band pass windows.

In another aspect the present invention provides a method of wavelength switching, comprising the steps of:

providing an optical waveguide having a grating along a section thereof, said grating comprising a pre-selected number of spaced sub-gratings with each sub-grating having a sub-grating period, said grating having a spectral response characterized by a pre-selected number of spaced band-pass windows spanning a pre-selected wavelength range; and

modifying at least one of said sub-grating period, refractive index and a combination of sub-grating period and refractive index of one or more selected said sub-gratings for opening or closing one or more selected band pass windows independently of all the other band pass windows.

The present invention provides a wavelength switchable optical filter, comprising:

a) an optical waveguide having a grating along a section thereof, said grating comprising a pre-selected number of spaced sub-gratings with each sub-grating having a sub-grating period, said grating having a spectral response characterized by alternating band stop windows and band pass windows spanning a selected wavelength range; and

b) modifying means connected to said optical waveguide for modifying at least one of said sub-grating period, refractive index and a combination of sub-grating period and refractive index of one or more selected said sub-gratings for selectively opening or closing at least one band-pass window and simultaneously closing or opening a band-stop window adjacent to said at least one band-pass window.

The present invention also provides an optical switching device, comprising:

a) a wavelength switchable optical filter including an optical waveguide having a grating along a section thereof and an optical input for receiving optical signals and an optical output, said grating comprising a pre-selected number of spaced sub-gratings with each sub-grating having a sub-grating period, said grating having a spectral response characterized by a pre-selected number of spaced band-pass windows spanning a pre-selected wavelength range, and modifying means connected to said optical waveguide for modifying at least one of said sub-grating period, refractive index and a combination of sub-grating period and refractive index of each individual sub-grating for selectively opening or closing each of said band pass windows independently of all the other band pass windows; and

b) optical branching means having at least first, second and third optical ports, said first optical port being an optical input port for receiving optical signals containing wavelengths within said pre-selected wavelength range, said optical branching means being optically connected through said second optical port to said optical input of said wavelength switchable optical filter.

The present invention also provides an optical switching device, comprising:

a) optical coupler means having an optical input for receiving optical signals and first and second optical coupler arms, a first wavelength switchable optical filter optically connected to said first optical coupler arm and a second wavelength switchable optical filter optically connected to said second optical coupler arm; and

b) said first and second wavelength switchable optical filters each including an optical waveguide having a grating along a section thereof and an optical input for receiving optical signals from said first and second optical coupler arms respectively, each of said first and second wavelength switchable optical filters having an optical output, each grating comprising a pre-selected number of spaced sub-gratings with each sub-grating have a sub-grating period, said grating having a spectral response characterized by a pre-selected number of spaced band-pass windows spanning a pre-selected wavelength range, and modifying means connected to said optical waveguide for modifying at least one of said sub-grating period, refractive index and a combination of sub-grating period and refractive index of each individual sub-grating for selectively opening or closing each of said band pass windows independently of all the other band pass windows.

The present invention also provides an optical switching device, comprising:

a) odd/even channel interleaver means including an interleaver optical input for receiving optical signals and first and second interleaver arms, a first wavelength switchable optical filter optically connected to said first interleaver arm and a second wavelength switchable optical filter optically connected to second interleaver arm;

b) said first and second wavelength switchable optical filters each including an optical waveguide having a grating along a section thereof and an optical input for receiving optical signals from said first and second optical coupler arms respectively, each of said first and second wavelength switchable optical filters having an optical output, each grating comprising a pre-selected number of spaced sub-gratings with each sub-grating having a sub-grating period, said grating having a spectral response characterized by a pre-selected number of spaced band-pass windows spanning a pre-selected wavelength range, and modifying means connected to said optical waveguide for modifying at least one of said sub-grating period, refractive index and a combination of sub-grating period and refractive index of each individual sub-grating for selectively opening or closing each of said band pass windows independently of all the other band pass windows; and

c) an optical coupler, said optical outputs of said first and second wavelength switchable optical filters being optically connected to said optical coupler for combining optical signals transmitted through said first and second wavelength switchable optical filters, said optical coupler having an optical output for outputting said combined optical signals.

### BRIEF DESCRIPTION OF THE DRAWINGS

The method and devices for randomly accessing and therefore adding and dropping a plurality of wavelengths forming the present invention will now be described below:

FIG. 1 is a functional block diagram showing a random access add/drop multiplexer;

FIG. 2 is a spectrum plot of the specially designed fiber grating that has comb responses (the dotted lines indicate the location and spectral width of each signal/channel);

FIG. 3 is a spectrum plot of the grating where one section has been actuated and hence the corresponding channel is no longer passed but reflected (dropped);

FIG. 4 is a block diagram showing an optical fiber containing a grating with transducers attached to fiber grating portion for locally changing either the pitch or index of refraction of the grating;

FIG. 5(a) is a schematic diagram of random express/drop configuration

FIG. 5(b) is a schematic diagram of random express/drop configuration with no express to drop cross talk;

FIG. 5(c) is an alternative design to achieve low express to drop cross talk with less insertion loss; and

FIG. 6 is a detailed schematic diagram of the optical circuit that includes the odd/even channel interleaver to convert channel spacing for dense WDM application.

### DETAILED DESCRIPTION OF THE INVENTION

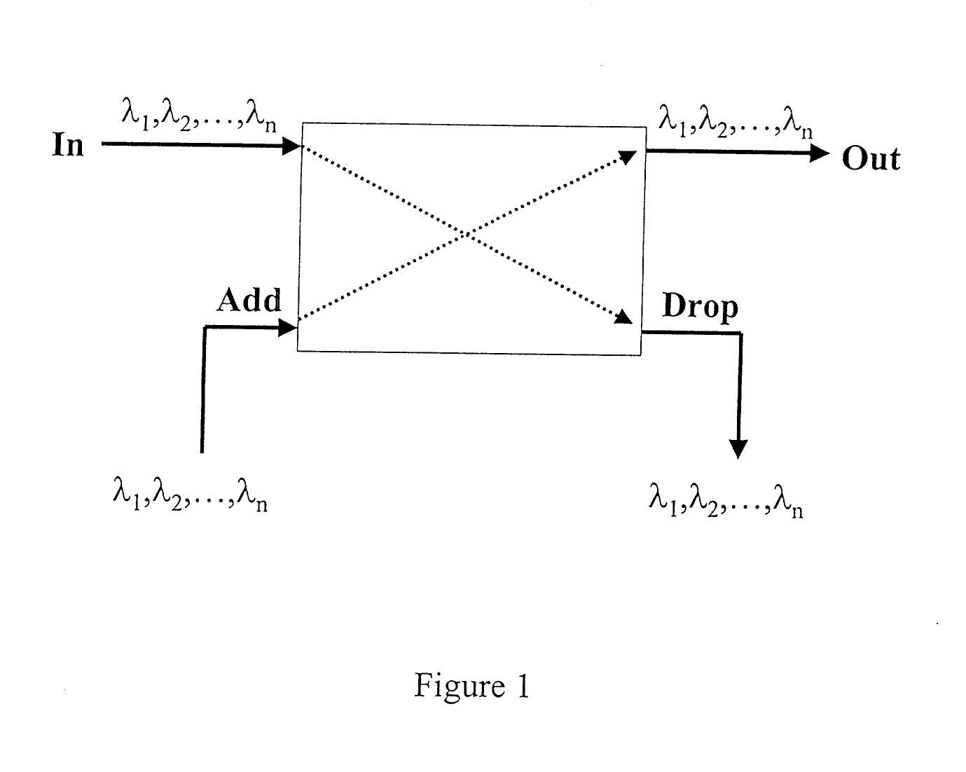

Optical Add/Drop Multiplexers (OADM), such as shown in FIG. 1, allow for the extracting and inserting individual wavelengths into a WDM signal. These devices are generally used to provide a limited amount of bandwidth to a specific site along an optical fiber route. However, as the optical network architecture migrates from point-to-point towards ring and eventually mesh structures, reconfigurable or dynamic OADMs will play an increasingly important role in directing traffic within the optical layer.

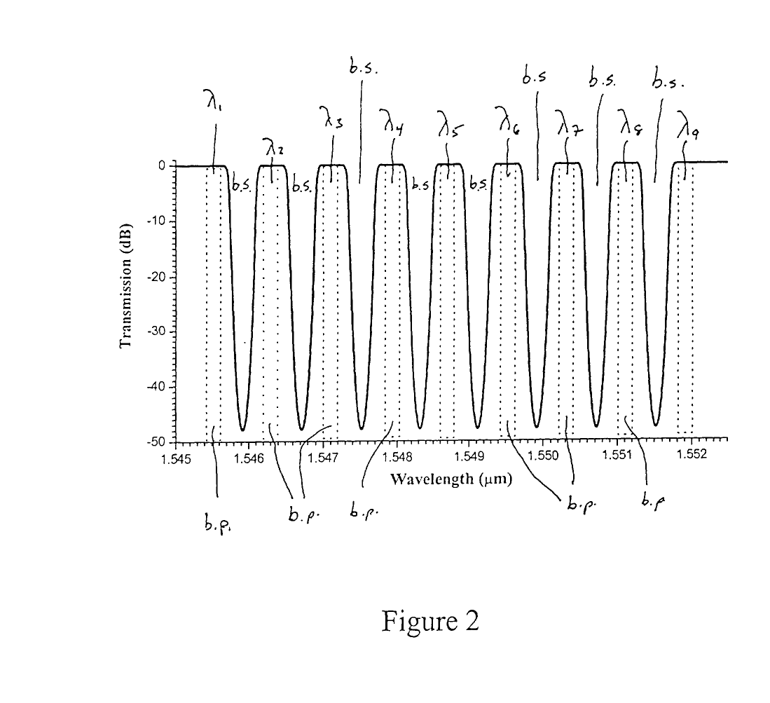

The present invention embodies the use of a fiber Bragg grating whose period or refractive index is altered through the use of a transduction mechanism along its length to provide passage or blockage to a specific wavelength or combination of wavelengths. In other words, the device would selectively open and close band-pass windows within a given channel spectrum and thereby integrate three fundamental functions into one: demultiplexing, switching and multiplexing. This is accomplished by using a fiber grating with comb-like filter spectrum coupled with a transduction mechanism in such a way that each pass band in the spectrum can be open or closed randomly without affecting other neighboring pass bands. FIG. 2 shows a spectrum plot of the specially designed fiber grating that has comb-like spectral response.

The comb-like spectrum in both transmission and reflection shown in FIG. 2 can be produced by using post grating writing processes to erase selective portions of a broadband grating along the grating length. Alternatively it can be achieved by using in-situ writing process to create the comb-like spectrum along the grating length. This gives a compound grating that has many sub-gratings, each sub-grating being separated by a gap that has no refractive index modulation. Therefore the compound grating has a spectral response characterized by a predetermined band stop (b.s.) region and band pass (b.p.) region spanning a selected wavelength range. The dotted lines located under the solid lines indicate the location and spectral width of each channel of wavelengths λ₁ to λ₉ and regions above the solid line represent the band stop regions alternating with the band pass regions.

While FIG. 2 shows a comb-like spectrum that has an alternating band pass and band stop regions, the spectrum does not need to be periodic in nature. In other words, the location of band pass and band stop can vary arbitrarily to match any WDM wavelength channel plan.

As a result of the grating design, different wavelengths of light are reflected at different locations along the length of a grating, it is then possible to isolate various sections of the spectrum by locally operating on specific lengths along the grating.

This provides a channelized approach, as is customary in optical communications, to operate on the carved-out spectrum. In other words, through careful design, it is possible to randomly select individual channels or wavelengths using this method. This is analogous to having multiple single gratings whose center wavelengths are offset such that there exist a wavelength gap between them. This wavelength gap then acts as a band pass while the gratings on either side of it act as band stop.

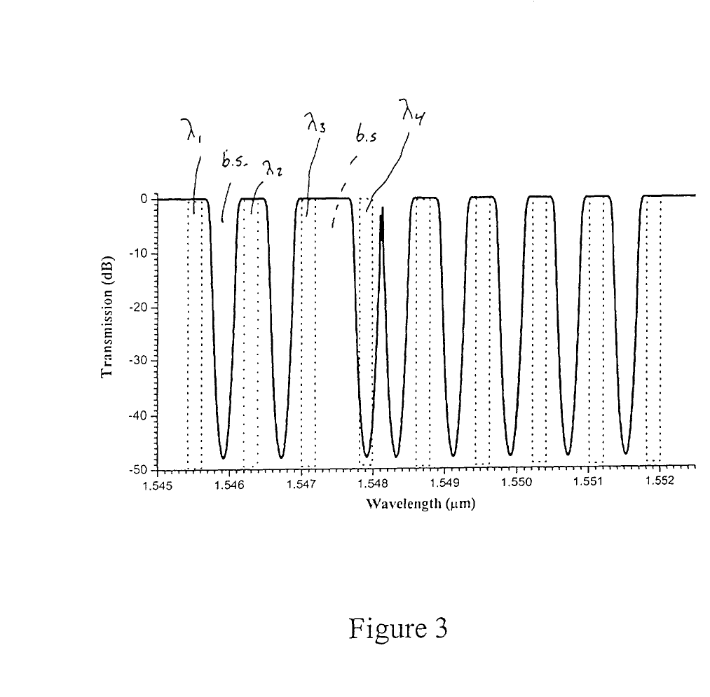

FIG. 3 is a spectrum plot of the grating where one section has been actuated and hence the corresponding channel (with wavelength of λ₄) is no longer passed but reflected (dropped) along the fiber. As a result of the actuation (switching), the band stop region next to the reflected channel becomes band pass region. While this has no effect on the incoming channels or wavelengths, it can be used to dynamically switch odd and even channels when configured in an interleaver manner. On the other hand, it is possible to maintain the band stop region throughout the actuation. This can be achieved by increasing band stop region during the actuation.

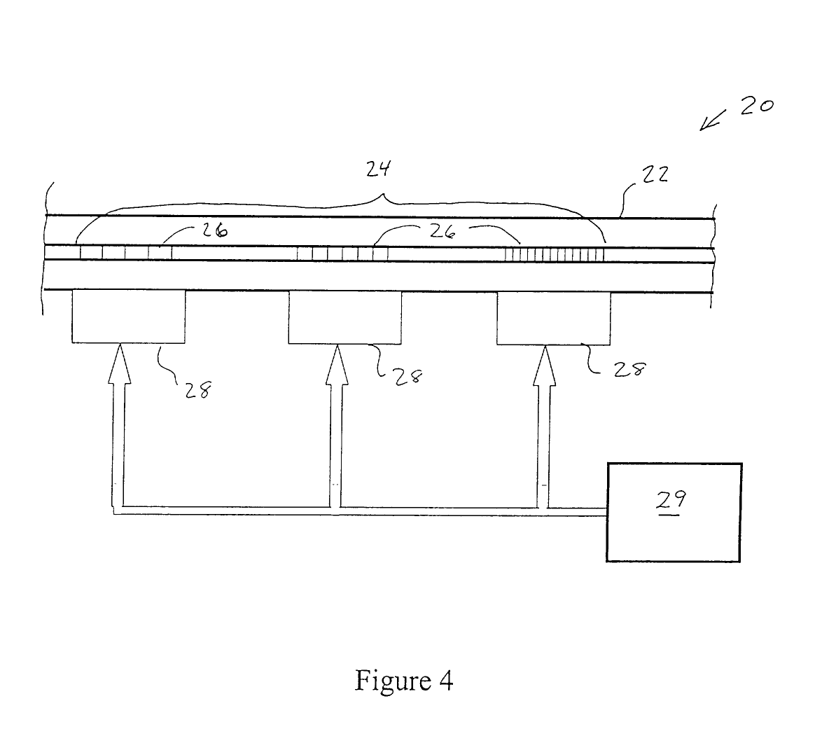

The transduction mechanism for modifying the pitch or refractive index could be based on strain or temperature or any other means for modifying the pitch or the index of refraction of that grating in a controlled manner. For example, an optical fiber section containing a grating and a transduction mechanism is shown generally at 20 in FIG. 4. An optical fiber 22 has a grating 24, which comprises a set of spaced sub-gratings 26 to give a comb-like transmission and reflection spectrum similar to the spectrum shown in FIG. 2. A number of piezoelectric elements 28 are attached along the fiber 22, each being adjacent to a sub-grating 26 for locally modifying the period and the refractive index of the sub-grating 26. Each piezoelectric element 28 is controlled independently by a power supply/controller 29 to select opening and closing of corresponding channels associated with a particular sub-grating 26 and hence different channels or wavelengths. Controller 29 may be a computer or microprocessor based controller.

In another embodiment of the device piezoelectric elements 28 could be replaced by heater elements for locally heating selected sub-gratings 26 that would change the local refractive index of that sub-grating 26 and or the period of that sub-grating 26.

One other significant advantage of the present invention over approaches that use spatial switches sandwiched by a multiplexer and a demultiplexer is that the present method and devices operate only on channels to be reconfigured while leaving the remaining band pass channels untouched. Stated differently, this wavelength switch can be configured to operate on a portion of a given input spectrum or the entire spectrum of the WDM signal band.

In one preferred embodiment of the invention a specially designed fiber grating is used such that its comb-like spectrum mimics that of multiple WDM channel/signals (evenly or un-evenly spaced). This grating will have a periodic wavelength structure with alternating (or arbitrary manner) band stop and band pass regions. The grating is then attached to a series of piezo-electric elements so as to align the piezo-electric elements 28 with the sub-gratings 26 (FIG. 4). In other words, if there are 16 band stop regions, then there are 16 piezo-electric elements 28. Application of a voltage to each and any one of these piezo-elements 28, would apply a predetermined amount of strain to the portion of the fiber 22 containing the grating 24. The grating is designed such that in the off position, input wavelengths fall within the band pass regions of the aforesaid grating 24. In the “on” position, one or more of the piezo-electric elements 28 are actuated through the controller 29 such that sub-grating associated with the actuated piezo-electric element 28 is switched and the corresponding channel or channels are reflected.

The method forming the present invention allows for switching channels on and off such that they are passed or blocked as they go through a specially designed fiber grating with the comb-like spectral response. Since fiber gratings are reflective in nature, light outside of the grating spectrum passes through the grating and is completely unaffected by it. The channels that fall within the spectrum of the grating are reflected or transmitted depending on the state of a transduction mechanism, which is set by a control signal.

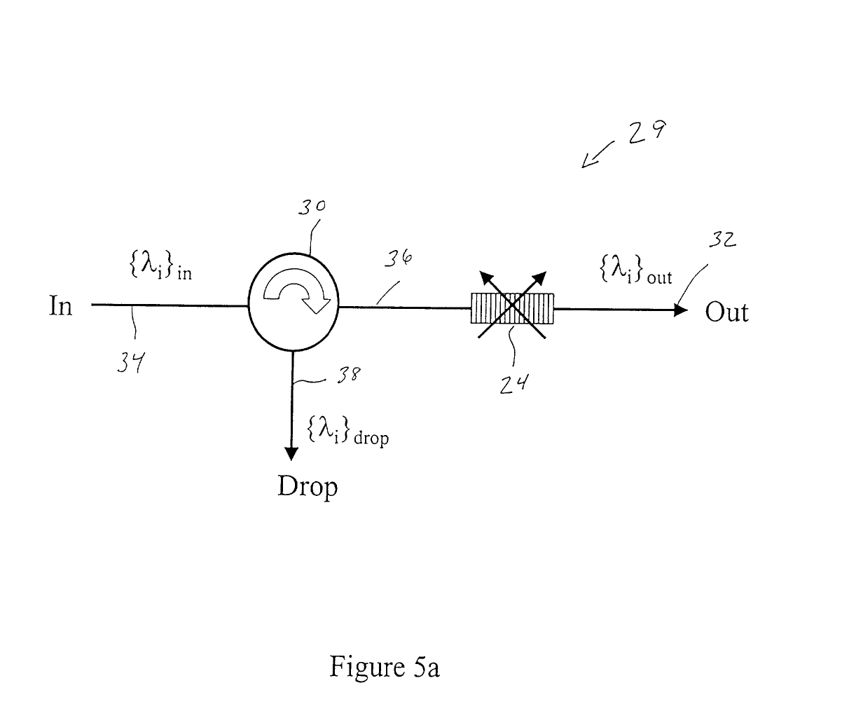

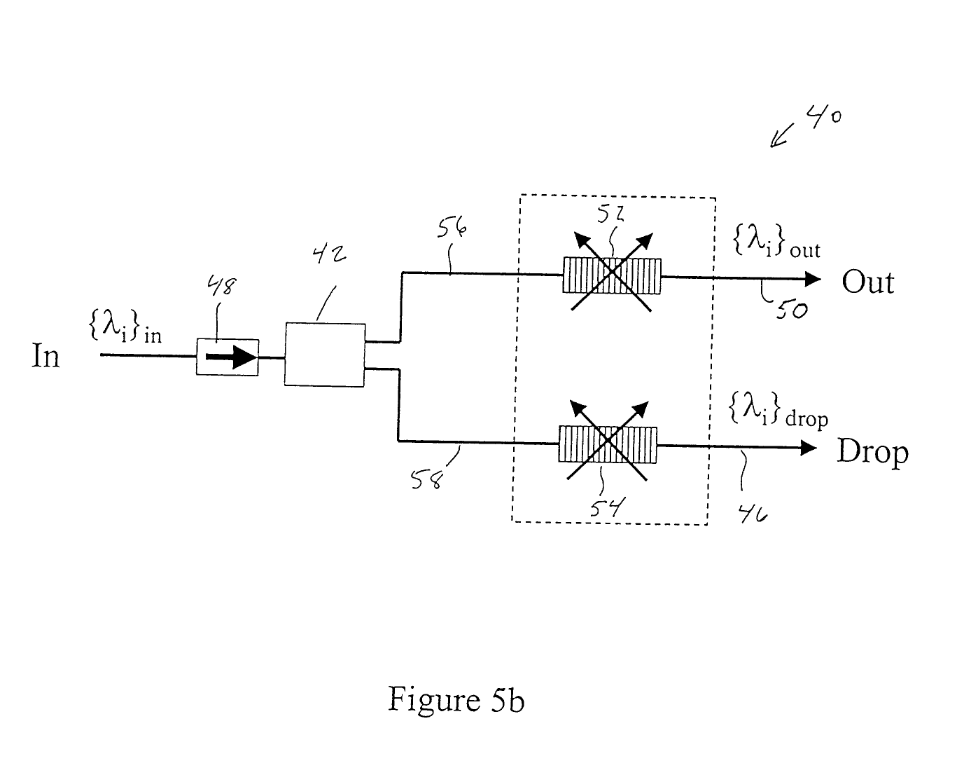

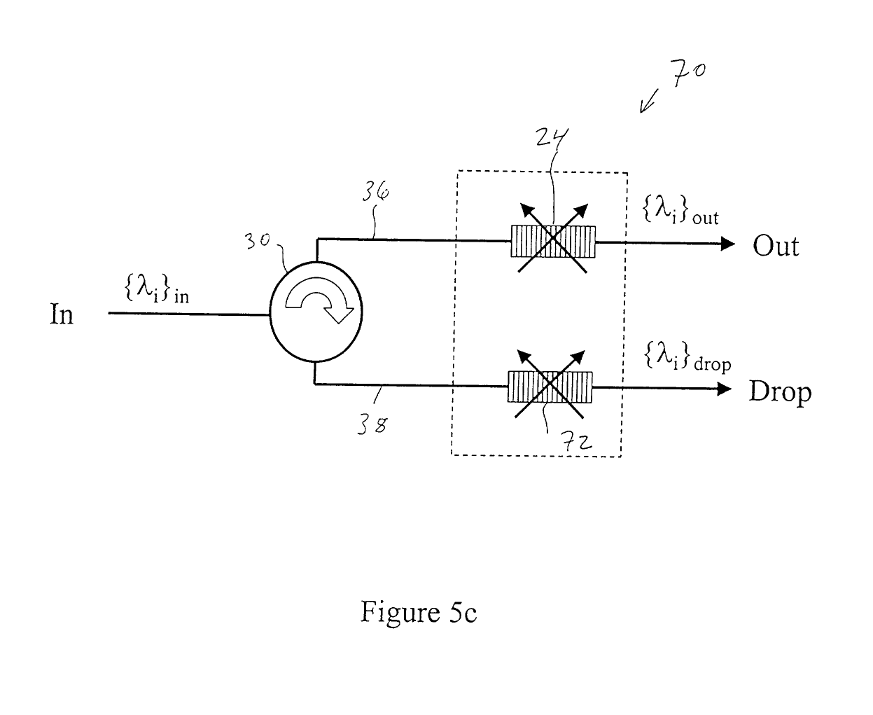

Referring to FIG. 5 (a), in the optical circuit 29 the optical path of the input, transmitted, and reflected light can be separated by using an optical branching device such as a directional coupler or an optical circulator 30 as shown. By connecting the switchable fiber grating device 24 to an optical branching device such as a fiber optic circulator 30, a three-port device is formed. In this optical circuit, light enters the input port 34 of the circulator 30 and is directed to its second port 36 where the fiber containing the switchable grating 24 is connected. Wavelengths that fall within the band pass of the switchable grating 24 are transmitted through and exit at the other end of the grating while wavelengths that fall within the band stop (i.e. outside of the pass band) are reflected and redirected to the third port 38 of the circulator 30. In this way, it is possible to arbitrarily switch the path of different wavelengths of light that fall within the bandwidth of the comb-like grating 24.

As disclosed above in relation to the grating with the spectal response shown in FIG. 2, this optical circuit 29 can be used as switchable interleaver when the channel spacing of input signals is one half of periodicity of comb-like filter such as the one shown in FIG. 2. In this case, when the switchable grating 24 is in the off-state, those channels with wavelengths aligned with the wavelengths of each sub-gratings (band stop regions) will be reflected to drop port 38 whilst those channels with wavelengths misaligned with wavelength of each sub-gratings (band pass region) will pass through the grating 24 to the output port 32. Accordingly, when the switchable grating 24 is in the on-state, all dropped channels will be now at the expressed port, and vice versa.

As a result of this arrangement between switchable grating 24 and its associated transduction mechanism, it is possible to switch an arbitrary set of wavelengths from input wavelengths. Similarly, it is equally possible to add back the same number of wavelengths or even a different set of wavelengths through a fourth port (not shown) such that they are summed at the output 32. Therefore the invention then embodies the use of a switchable fiber Bragg grating 24 together with a fiber optic branching device to form multiple outputs such that selected portions of a desired spectrum can be redirected through output port 38 on circulator 30.

Referring to FIG. 5(b), a schematic diagram of an optical circuit 40 that uses a fiber coupler 42 is shown. The advantage of this design is that it completely eliminates the cross talk between out (express) channels being output at output port 50 and drop channels at drop port 46. In other words, there will be no express channels present at drop port 46 at any time. This is achieved by use an optical isolator 48 and two gratings 52 and 54, one being located in the coupler arm 56 and the other in coupler arm 58. The isolator 48 blocks any unwanted channels reflected by either grating 52 or 54. Since input channels are present in both output arms 56 and 58 of the coupler, either arm can be used as express or drop port. This optical circuit 40 has an added benefit over optical circuit 29 (FIG. 5(a)) because it has a much lower insertion loss variation in the drop path due to the fact that the drop channels are transmitted through pass the band of the grating. In addition, optimizing the coupling ratio of the coupler 42 can minimize insertion loss of the express path. Another interesting point is that, by offsetting one of the gratings by one half of channel spacing between the spectrum of two gratings 52 and 54, it is possible to have only one set of transducers to switch both gratings and hence reduces the cost of the device. If needed, a band stop filter can always be used in the drop path to stop any non-operational channels.

FIG. 5(c) is a schematic diagram of another embodiment of an optical circuit 70 that is similar to the optical circuit 29 in FIG. 5(a) except with the addition of switchable grating 72 at drop port 38. This provides a reduced cross-talk from the express channels to drop channels and lower insertion loss. The uniqueness of this arrangement is that switchable grating 24 in the express path acts as a wavelength switch whereas switchable grating 72 in the drop path acts as a wavelength block filter. This becomes possible when the spectrum of two switchable gratings 24 and 72 for each given channel is offset by one half of the channel spacing. In this way, when an optical signal is passing through between any two un-switched gratings, unwanted reflection (cross-talk) from the express path will be blocked by the filter grating 72 at the drop path. Accordingly when an input channel is reflected by the switchable filter grating 24, the switchable filter grating 72 will be tuned out to allow the dropped channel pass through. As disclosed above in relation to device 40 in FIG. 5b, it is possible to have only one set of transducers to switch both gratings and hence reduces the cost of the device.

While the gratings in wavelength switchable optical filters 24 and 72 may have the same spectral response, the strength of wavelength block filter 72 can be lower than that of wavelength switchable filter 24 in order to reduce the degree of control in grating fabrication and hence the cost of grating manufacturing.

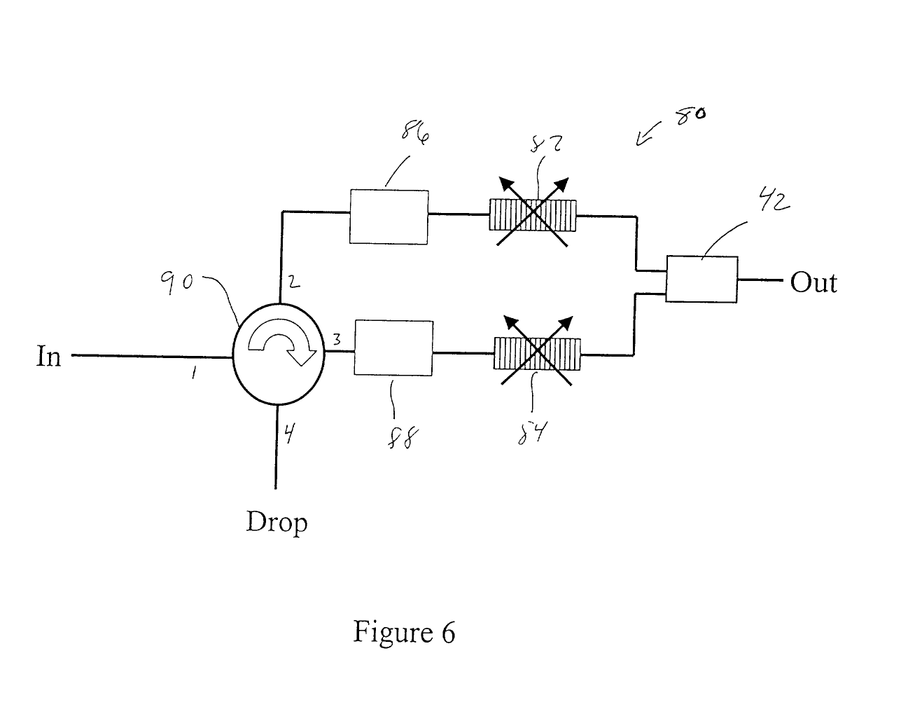

FIG. 6 shows a detailed schematic diagram of an optical circuit 80 that includes an odd/even channel interleaver to convert channel spacing for dense WDM application. Optical circuit 80 includes a four-port optical circuit 90 with ports labeled 1, 2, 3 and 4 and port 1 being the input port. The odd/even channel interleaver is then formed using odd channel filter 88 and even channel filter 86.

In this embodiment, the even channel filter 86 connected to port 2 of the circulator 90 will pass only even channels and reflect odd channels whereas the odd channel filter 88 connected to port 3 of the circulator 90 will pass odd channels and reflect even channels. Similarly, switchable gratings 82 and 84 that follow even and odd channel filters at port 2 and port 3 address even and odd channels, respectively. Since both filters 86 and 88 cover only the operational band, any non-operational channels will not be affected by the filtering function. The expressed channels from both even path and odd path are combined together via a fiber coupler 42 at the output port. The dropped channels from either even or odd paths will be routed to the drop port via the port 4 of the circulator 90. The underlying importance of this design is that it reduces the stringent requirement for the switchable gratings when input WDM channel spacing becomes very close.

As will be understood by those skilled in the art, optical add/drop multiplexers provide the means for extracting and inserting a known and fixed number of wavelengths from and into a wavelength division multiplexed signal while allowing other wavelengths to pass through. The present invention embodies a random access optical add/drop multiplexer in that there is flexibility in accessing any one or combination of wavelengths from a given input set of wavelengths. This provides the freedom to design flexible optical networks needed to deliver cost effective bandwidth with improved management at the optical layer of communication networks.

The present invention differs from the prior art in two respects. First, the present invention only uses a single grating to address multiple wavelengths allowing for better manufacturability, lower insertion loss and cost, and secondly, the wavelength selection process used in the present invention is based on switching rather than tuning. This is primarily due to the fact that the transduction mechanism for detuning the grating has only two states, on and off.

While forming the gratings with the comb-like spectral response in optical fibers is preferred, it will be appreciated that any waveguide in which these gratings can be produced may be used as long as they can be coupled to an appropriate transduction mechanism. For example the gratings may be written into photosensitive semiconductor waveguides which may then be coupled to, for example, temperature controllers for locally modifying the index of refraction of different parts of the grating for switching wavelengths.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A wavelength switchable optical filter, comprising:
b) an optical waveguide having a grating along a section thereof, said grating comprising a pre-selected number of spaced sub-gratings with each sub-grating having a sub-grating period, said grating having a spectral response characterized by a pre-selected number of spaced band-pass windows spanning a pre-selected wavelength range; and
b) modifying means connected to said optical waveguide for modifying at least one of said sub-grating period, refractive index and a combination of sub-grating period and refractive index of each individual sub-grating for selectively opening or closing each of said band pass windows independently of all the other band pass windows.

2. The wavelength switchable optical filter according to claim 1 wherein said optical waveguide is an optical fiber.

3. The wavelength switchable optical filter according to claim 2 wherein said modifying means includes transduction means attached along an outer surface of said optical fiber adjacent to said sub-gratings for applying a pre-determined amount of strain individually to each sub-grating independent of the other sub-gratings for modifying the period of one or more of said sub-gratings.

4. The wavelength switchable optical filter according to claim 3 wherein said transduction means includes a plurality of piezoelectric elements with a separate piezoelectric element attached to said optical fiber adjacent to each separate sub-grating and including power supply control means for controlling a voltage on each piezoelectric element independent of a voltage applied on the other piezoelectric elements.

5. The wavelength switchable optical filter according to claim 4 wherein the number of piezoelectric elements attached to said outer surface of said optical fiber is equal to the number of sub-gratings in said grating.

6. The wavelength switchable optical filter according to claim 3 wherein said transduction means includes temperature control means for independently controlling the temperature of each sub-grating.

7. A method of wavelength switching, comprising the steps of:
providing an optical waveguide having a grating along a section thereof, said grating comprising a pre-selected number of spaced sub-gratings with each sub-grating having a sub-grating period, said grating having a spectral response characterized by a pre-selected number of spaced band-pass windows spanning a pre-selected wavelength range; and
modifying at least one of said sub-grating period, refractive index and a combination of sub-grating period and refractive index of one or more selected said sub-gratings for opening or closing one or more selected band pass windows independently of all the other band pass windows.

8. The method according to claim 7 wherein said optical waveguide is an optical fiber.

9. The method according to claim 8 wherein said step of modifying includes activating a transduction means attached along an outer surface of said optical fiber adjacent to said sub-gratings for applying a pre-determined amount of strain individually to each sub-grating independent of the other sub-gratings for modifying the period of one or more of said sub-gratings.

10. The method according to claim 9 wherein said transduction means is a separate piezoelectric element attached to said optical fiber adjacent to each sub-grating, and wherein the step of modifying means includes activating one or more of said piezoelectric elements.

11. The method according to claim 9 wherein said transduction means includes temperature control means for independently controlling the temperature of each sub-grating.

12. A wavelength switchable optical filter, comprising:
b) an optical waveguide having a grating along a section thereof, said grating comprising a pre-selected number of spaced sub-gratings with each sub-grating having a sub-grating period, said grating having a spectral response characterized by alternating band stop windows and band pass windows spanning a selected wavelength range; and
b) modifying means connected to said optical waveguide for modifying at least one of said sub-grating period, refractive index and a combination of sub-grating period and refractive index of one or more selected said sub-gratings for selectively opening or closing at least one band-pass window and simultaneously closing or opening a band-stop window adjacent to said at least one band-pass window.

13. The wavelength switchable optical filter according to claim 12 wherein said optical waveguide is an optical fiber.

14. The wavelength switchable optical filter according to claim 13 wherein said modifying means includes transduction means attached along an outer surface of said optical fiber adjacent to said sub-gratings for applying a pre-determined amount of strain individually to each sub-grating independent of the other sub-gratings for modifying the period of one or more of said sub-gratings.

15. The wavelength switchable optical filter according to claim 14 wherein said transduction means includes a plurality of piezoelectric elements with a separate piezoelectric element attached to said optical fiber adjacent to each separate sub-grating and including power supply control means for controlling a voltage on each piezoelectric element independent of a voltage applied on the other piezoelectric elements.

16. The wavelength switchable optical filter according to claim 15 wherein the number of piezoelectric elements attached to said outer surface of said optical fiber is equal to the number of sub-gratings in said grating.

17. The wavelength switchable optical filter according to claim 14 wherein said transduction means includes temperature control means for independently controlling the temperature of each sub-grating.

18. An optical switching device, comprising:
b) a wavelength switchable optical filter including an optical waveguide having a grating along a section thereof and an optical input for receiving optical signals and an optical output, said grating comprising a pre-selected number of spaced sub-gratings with each sub-grating having a sub-grating period, said grating having a spectral response characterized by a pre-selected number of spaced band-pass windows spanning a pre-selected wavelength range, and modifying means connected to said optical waveguide for modifying at least one of said sub-grating period, refractive index and a combination of sub-grating period and refractive index of each individual sub-grating for selectively opening or closing each of said band pass windows independently of all the other band pass windows; and
b) optical branching means having at least first, second and third optical ports, said first optical port being an optical input port for receiving optical signals containing wavelengths within said pre-selected wavelength range, said optical branching means being optically connected through said second optical port to said optical input of said wavelength switchable optical filter.

19. The optical switching device according to claim 18 wherein said optical waveguide is an optical fiber.

20. The optical switching device according to claim 18 wherein said optical branching means is an optical circulator.

21. The optical switching device according to claim 19 wherein said modifying means includes transduction means attached along an outer surface of said optical fiber adjacent to said sub-gratings for applying a pre-determined amount of strain individually to each sub-grating independent of the other sub-gratings for modifying the period of one or more of said sub-gratings.

22. The optical switching device according to claim 21 wherein said transduction means includes a plurality of piezoelectric elements with a separate piezoelectric element attached to said optical fiber adjacent to each separate sub-grating and including power supply control means for controlling a voltage on each piezoelectric element independent of a voltage applied on the other piezoelectric elements.

23. The optical switching device according to claim 22 wherein the number of piezoelectric elements attached to said outer surface of said optical fiber is equal to the number of sub-gratings in said grating.

24. The wavelength switchable optical filter according to claim 21 wherein said transduction means includes temperature control means for independently controlling the temperature of each sub-grating.

25. The optical switching device according to claim 18 wherein said wavelength switchable optical filter is a first wavelength switchable optical filter, including a second wavelength switchable optical filter optically connected to said third optical port of said optical branching means.

26. The optical switching device according to claim 25 wherein said gratings in said first and second wavelength switchable optical filters are substantially the same having substantially the same spectral response.

27. The optical switching device according to claim 25 wherein said gratings in said first and second wavelength switchable optical filters are different from each other therefore having different spectral responses.

28. The optical switching device according to claim 25 wherein said optical waveguides of said first and second wavelength switchable optical filters are first and second optical fibers respectively.

29. The optical switching device according to claim 28 wherein said modifying means includes transduction means attached along an outer surface of each of said first and second optical fibers and positioned adjacent to said sub-gratings in each of said first and second optical fiber for applying a pre-determined amount of strain individually to each sub-grating independent of the other sub-gratings in said grating in each of said first and second optical fibers for modifying the period of one or more of said sub-gratings.

30. The optical switching device according to claim 29 wherein said transduction means includes a first set of piezoelectric elements with a piezoelectric elements from said first set being attached to said first optical fiber adjacent to each sub-grating in said first fiber, and including a second set of piezoelectric elements with piezoelectric elements from said second set being attached to said second optical fiber adjacent to each sub-grating in said second optical fiber, and including power supply control means for controlling a voltage on each piezoelectric element independent of a voltage applied on the other piezoelectric elements.

31. The optical switching device according to claim 30 wherein said gratings of said first and wavelength switchable optical filters are offset with respect to each other so that the spectrum of one of said gratings is offset with respect to the spectrum of the other grating by one half of a channel spacing, and wherein said first and second optical fibers are aligned together so that the gratings in each fiber are aligned side by side, and wherein said first set of piezoelectric elements is also the second set of piezoelectric elements so that each piezoelectric element is bonded to both said first and second optical fibers and is adjacent to a sub-grating in each of said first and second optical fibers, and including power supply control means for controlling a voltage on each piezoelectric element independent of a voltage applied on the other piezoelectric elements.

32. An optical switching device, comprising:
a) optical coupler means having an optical input for receiving optical signals and first and second optical coupler arms, a first wavelength switchable optical filter optically connected to said first optical coupler arm and a second wavelength switchable optical filter optically connected to said second optical coupler arm; and
b) said first and second wavelength switchable optical filters each including an optical waveguide having a grating along a section thereof and an optical input for receiving optical signals from said first and second optical coupler arms respectively, each of said first and second wavelength switchable optical filters having an optical output, each grating comprising a pre-selected number of spaced sub-gratings with each sub-grating have a sub-grating period, said grating having a spectral response characterized by a pre-selected number of spaced band-pass windows spanning a pre-selected wavelength range, and modifying means connected to said optical waveguide for modifying at least one of said sub-grating period, refractive index and a combination of sub-grating period and refractive index of each individual sub-grating for selectively opening or closing each of said band pass windows independently of all the other band pass windows.

33. The optical switching device according to claim 32 including an optical isolator optically connected to said optical input of said optical branching means.

34. The optical switching device according to claim 33 wherein said optical waveguides of said first and second wavelength switchable optical filters are first and second optical fibers respectively.

35. The optical switching device according to claim 34 wherein said modifying means includes transduction means attached along an outer surface of each of said first and second optical fibers and positioned adjacent to said sub-gratings in each of said first and second optical fiber for applying a pre-determined amount of strain individually to each sub-grating independent of the other sub-gratings in said grating in each of said first and second optical fibers for modifying the period of one or more of said sub-gratings.

36. The optical switching device according to claim 35 wherein said transduction means includes a first set of piezoelectric elements with a piezoelectric elements from said first set being attached to said first optical fiber adjacent to each sub-grating in said first fiber, and including a second set of piezoelectric elements with piezoelectric elements from said second set being attached to said second optical fiber adjacent to each sub-grating in said second optical fiber, and including power supply control means for controlling a voltage on each piezoelectric element independent of a voltage applied on the other piezoelectric elements.

37. The optical switching device according to claim 36 wherein said gratings of said first and second wavelength switchable optical filters are offset with respect to each other so that the spectrum of one of said gratings is offset with respect to the spectrum of the other grating by one half of a channel spacing, and wherein said first and second optical fibers are aligned together so that the gratings in each fiber are aligned side by side, and wherein said first set of piezoelectric elements is also the second set of piezoelectric elements so that each piezoelectric element is bonded to both said first and second optical fibers and is adjacent to a sub-grating in each of said first and second optical fibers, and including power supply control means for controlling a voltage on each piezoelectric element independent of a voltage applied on the other piezoelectric elements.

38. An optical switching device, comprising:
a) odd/even channel interleaver means including an interleaver optical input for receiving optical signals and first and second interleaver arms, a first wavelength switchable optical filter optically connected to said first interleaver arm and a second wavelength switchable optical filter optically connected to second interleaver arm;
b) said first and second wavelength switchable optical filters each including an optical waveguide having a grating along a section thereof and an optical input for receiving optical signals from said first and second optical coupler arms respectively, each of said first and second wavelength switchable optical filters having an optical output, each grating comprising a pre-selected number of spaced sub-gratings with each sub-grating having a sub-grating period, said grating having a spectral response characterized by a pre-selected number of spaced band-pass windows spanning a pre-selected wavelength range, and modifying means connected to said optical waveguide for modifying at least one of said sub-grating period, refractive index and a combination of sub-grating period and refractive index of each individual sub-grating for selectively opening or closing each of said band pass windows independently of all the other band pass windows; and
c) an optical coupler, said optical outputs of said first and second wavelength switchable optical filters being optically connected to said optical coupler for combining optical signals transmitted through said first and second wavelength switchable optical filters, said optical coupler having an optical output for outputting said combined optical signals.

39. The optical switching device according to claim 38 wherein said odd/even channel interleaver means includes an optical branching means having first, second, third and fourth optical ports, wherein said first optical port is the interleaver input port, said first interleaver arm including an odd channel filter means connected to said second optical port for passing channels containing odd wavelengths in a pre-selected wavelength range and reflecting even wavelengths in said pre-selected wavelength range, said second interleaver arm including an even channel filter means connected to said third optical port for passing channels containing even wavelengths and reflecting odd wavelengths, said first wavelength switchable optical filter input being optically connected to said odd channel filter and said second wavelength switchable optical filter input being optically connected to said even channel filter, and wherein said fourth optical port is a drop port.

40. The optical switching device according to claim 39 wherein said optical waveguides are optical fibers.

41. The optical switching device according to claim 18 wherein said grating has a pre-selected spectral response characterized by alternating band stop windows and band pass windows spanning a selected wavelength range, and wherein a channel spacing of input signals is one half of a periodicity of said pre-selected spectral response so that when said switchable grating is in an off-state, those channels with wavelengths aligned with wavelengths of each of said band stop windows will be reflected to said third optical port of said optical branching means while those channels with wavelengths mis-aligned with wavelength of each band pass region will pass through the switchable grating to an output port of said wavelength switchable grating, and when said switchable grating is in an on-state, all dropped channels will pass to said output port of said wavelength switchable grating, and vice versa.
